(19) United States
(12) Patent Application Publication
(10) Pub. No.: US 2006/0068270 A1
(43) Pub. Date: Mar. 30, 2006

(54) Solid polymer electrolyte fuel battery cell and fuel battery using same

(76) Inventors: Juichi Ino, Tokyo (JP); Noriaki Sato, Tokyo (JP); Atsushi Asada, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/538,804

(22) PCT Filed: Dec. 22, 2003
(86) PCT No.: PCT/JP03/16501

§ 371 Date: Aug. 16, 2005

(30) Foreign Application Priority Data
Dec. 24, 2002 (JP) 2002-371763

(51) Int. Cl. H01M 4/86; H01M 8/10

(52) U.S. Cl. 429/44; 429/30

(57) ABSTRACT

The present invention provides a solid polymer electrolyte fuel battery cell comprising a solid polymer electrolyte membrane, a fuel electrode and an oxidant electrode, the both electrodes being disposed on both sides of the membrane, and a pair of current collectors disposed outside the electrodes, wherein a water-retaining material comprising fibers at least the surface layer of which contains a metal oxide is combined and integrated with at least the fuel electrode among the solid polymer electrolyte membrane, the fuel electrode and the oxidant electrode. The solid polymer electrolyte fuel battery cell can be operated with stability without use of complicated auxiliary devices such as a humidifier.

### TECHNICAL FIELD

The present invention relates to solid polymer electrolyte fuel battery, and more particularly, to solid polymer electrolyte fuel battery cells that can work properly even when supplied with no or only a small amount of water from outside into the inside battery cells.

### BACKGROUND ART

Solid polymer electrolyte fuel cells, which are fuel cells using polymers as the electrolyte, have been developed actively for cogeneration system applications for home use and automotive applications because of their high energy conversion efficiency at a low operation temperature and also because of their small size and light weight.

In a normal solid polymer electrolyte fuel cell, as shown in FIG. 1 (a schematic illustration of a battery cell), a catalyst layer in contact with a polymer electrolyte membrane surface of a fuel electrode 2 (anode) composed of a catalyst layer 2a and a gas diffusion layer 2b ionizes the fuel, such as hydrogen and methanol, to form protons and electrons. The electrons move to an oxidant electrode 3 (the cathode composed of a catalyst layer 3a and a gas diffusion layer 3b) through an external circuit, and the protons move to the oxidant electrode 3 through an electrolyte membrane 1. On the surface of the oxidant electrode 3, the protons which have moved from the fuel electrode 2 through the electrolyte membrane 1 react with the electrons which have flown through the external circuit and the oxygen captured from the outside, resulting in formation of water 8 depicted in the figure. In the figure, numerals 4, 5 and 6 represent a current collector, a fuel gas passageway and an oxidizer gas (oxygen) passageway, respectively.

The reactions which occur on the individual electrodes are shown below.

Reaction on the fuel electrode:
H₂→2H⁺+2e⁻

Reaction on the oxidant electrode:
1/2O₂+2H⁺+2e⁻→H₂O
Each current collector is electrically connected to the fuel electrode 2 or the oxidant electrode 3. With the movement of protons in the solid polymer membrane from the fuel electrode toward the oxidant electrode, water molecules also move from the fuel electrode toward the oxidant electrode in the solid polymer membrane. As the result, the solid polymer membrane dries gradually from its anode side.

In order for an electrolyte membrane to have high proton conductivity, the presence of water is important. There is a tendency that the higher the water content in the electrolyte membrane is, the higher the proton conductivity becomes. The water content varies depending on the operation condition, namely the humidity of the gas fed. There has been, therefore, a problem in that a shortage of water will decrease the ion conductivity, resulting in decline of the power of the fuel battery.

In order to prevent this problem, the fuel gas to be injected into the fuel electrode must be humidified. For this purpose, a humidifier is needed to be mounted. This will cause a problem in that the whole system is lacking in compactness and is complicated. In addition, there has been another problem that the amount of water generated at the oxidant electrode increases, and the water will cover the oxidant electrode to inhibit the reaction if it is not drained.

In order to overcome these problems, various proposals have been made, such as a system in which a porous membrane applied with a hydrophilic resin or subjected to hydrophilization is disposed within or around an electrode or on the electrolyte membrane, and water is supplied through the porous membrane (JP 1994-84533 A); a system in which a moisture conditioning layer comprising a moisture absorption/desorption material made of fine particles such as silicate, aluminate and zeolite sandwiched between nonwoven fabrics is disposed between an electrode and a current collector or between a current collector and a container for enclosing a fuel battery therein (JP 2002-270199 A), a system in which electrically insulating ceramic particle spacers are incorporated in a polymer electrolyte layer (JP 2001-76745 A); and a system in which an inorganic glass membrane with proton conductivity is laminated to a solid polymer electrolyte on its fuel electrode side or oxidant electrode side (JP 2000-285933 A). Another proposal is to cover the gas phase-side surface of the electrolyte in an electrode with a water repellent layer to inhibit the water discharge from the electrode, thereby returning the water to the solid polymer electrolyte membrane to humidify it (JP 2002-203569 A).

### DISCLOSURE OF THE INVENTION

Some electrolyte membranes, however, show sulfuric acid acidity, and there is a problem in that when a hydrophilic resin is used, the resin itself is decomposed under a sulfuric acid-acidic atmosphere at a high temperature, and fuel battery characteristics are adversely affected. Use of an inorganic moisture absorbent will remove such a fear. If it is, however, used in the form of particles or it is used only between an electrode and an electrolyte membrane, the humidity can be retained around the absorbent, but it is difficult to supply water. It is, therefore, insufficient for operating fuel batteries under low- or non-humidity conditions.

Also in the case of covering the gas phase-side surface of the electrolyte membrane with a water repellent layer, the drain of water from the electrode catalyst layer is inhibited, but it is insufficient to humidify the electrolyte in the catalyst layer located on the fuel electrode side where the humidity is the lowest.

The present invention has been made in light of these problems. The present invention intends to provide a solid polymer electrolyte fuel battery which can be operated with stability without use of complicated auxiliary devices such as a humidifier under any environment by preventing the solid polymer electrolyte membrane or fuel electrode of the fuel battery from drying by efficiently returning water generated at the oxidant electrode to the solid polymer electrolyte membrane or the fuel electrode.

The present invention provides a solid polymer electrolyte fuel battery cell comprising a solid polymer electrolyte membrane, a fuel electrode and an oxidant electrode, the both electrodes being disposed on both sides of the membrane, and a pair of current collectors disposed outside the electrodes, wherein a water-retaining material comprising the fibers at least the surface layer of which contains a metal oxide is combined and integrated with at least the fuel electrode among the above-mentioned solid polymer electrolyte membrane, the above-mentioned fuel electrode, and the above-mentioned oxidant electrode. The present inventors have found, after their various investigations, that the above-mentioned certain fibers can transfer water efficiently from the oxidant electrode to the fuel electrode due to the water permeation phenomenon or capillary phenomenon of the said fibers and thereby make the fibers of the fuel electrode absorb the water.

### BRIEF DESCRIPTION OF THE DRAWINGS

FIG. 1 shows a schematic illustration of a conventional solid polymer electrolyte fuel battery cell;

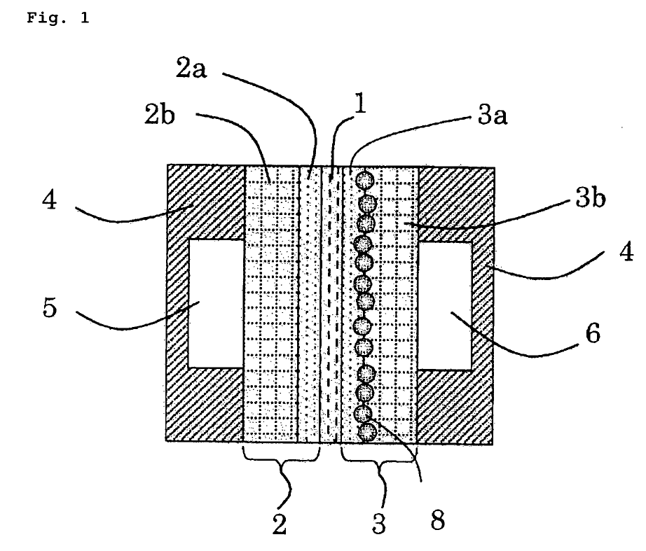

FIG. 2 is a schematic illustration of a solid polymer electrolyte fuel battery cell in which a water-retaining material of the present invention is continuously combined and integrated from the inside of the oxidant electrode to the inside of the fuel electrode through the solid polymer electrolyte; and

FIG. 3 is a schematic illustration of a solid polymer electrolyte fuel battery cell in which a water-retaining material of the present invention is continuously combined and integrated to the insides of both electrodes and an external portion of the cell.

In the figures, numeral 1 indicates a solid polymer electrolyte, numeral 2 indicates a fuel electrode, numeral 2a indicates a catalyst layer, numeral 2b indicates a gas diffusion layer, numeral 3 indicates an oxidant electrode, numeral 3a indicates a catalyst layer, numeral 3b indicates a gas diffusion layer, numeral 4 indicates a current collector, numeral 5 indicates a fuel gas passageway, numeral 6 indicates an oxidant gas passageway, numeral 7 indicates a water-retaining material, and numeral 8 indicates water.

### BEST MODE FOR CARRYING OUT THE INVENTION

Embodiments of the present invention will be described in detail below.

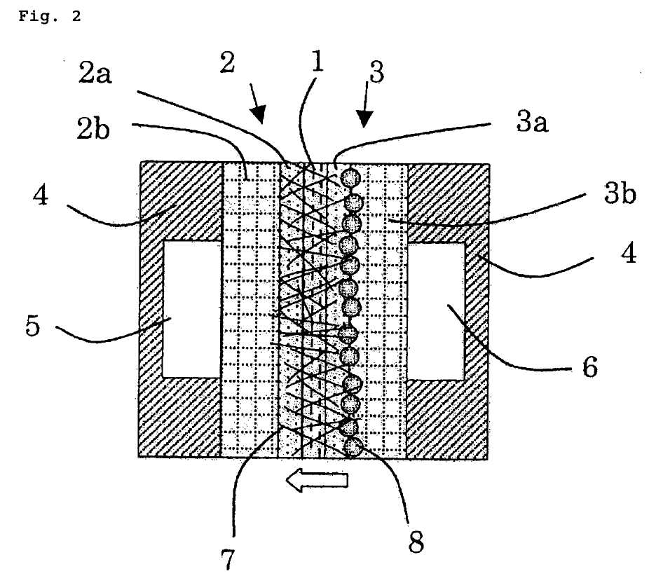

Inside a fuel battery cell of the present invention, a water-retaining material comprising the fibers at least the surface layer of which contains a metal oxide is combined and integrated with at least the fuel electrode among the above-mentioned solid polymer electrolyte membrane, the above-mentioned fuel electrode and the above-mentioned oxidant electrode. The water-retaining material is combined and integrated with at least the inside of the fuel electrode among the above-mentioned solid polymer electrolyte membrane, the above-mentioned fuel electrode, and the above-mentioned oxidant electrode. As a result, the drying which occurs in the fuel electrode is inhibited and the action of the battery is stabilized. The water-retaining material is preferably combined and integrated with both of the fuel electrode and the inside of the solid polymer electrolyte membrane. More preferably, a water-retaining material 7 is combined and integrated with all of a fuel electrode 2, a solid polymer electrolyte membrane 1 and an oxidant electrode 3 as shown in FIG. 2. Numeral 2a indicates a catalyst layer of the fuel electrode 2. Numeral 2b indicates a gas diffusion layer of the fuel electrode 2. Numeral 3a indicates a catalyst layer of the oxidant electrode 3. Numeral 3b indicates a gas diffusion layer of the oxidant electrode 3. Numeral 4 indicates a current collector. Numeral 5 indicates a fuel gas passageway. Numeral 6 indicates an oxidant gas (oxygen) passageway. Regarding the fibers combined and integrated with the fuel electrode, solid polymer membrane or oxidant electrode, the scattered fibers may be dispersed in the fuel electrode catalyst, the solid polymer membrane or the oxidant electrode catalyst. Alternatively, the fuel electrode catalyst, the electrolyte or the oxidant electrode catalyst may be packed in or carried on the fiber cloth. In such structures, the water-retaining material exhibits a water retaining effect in its surface and also absorbs water 8 generated at the oxidant electrode. In addition, it can transport the water efficiently in the arrow direction indicated in the figure toward the low-humidity side, that is to say, toward the solid polymer electrolyte membrane or the fuel electrode.

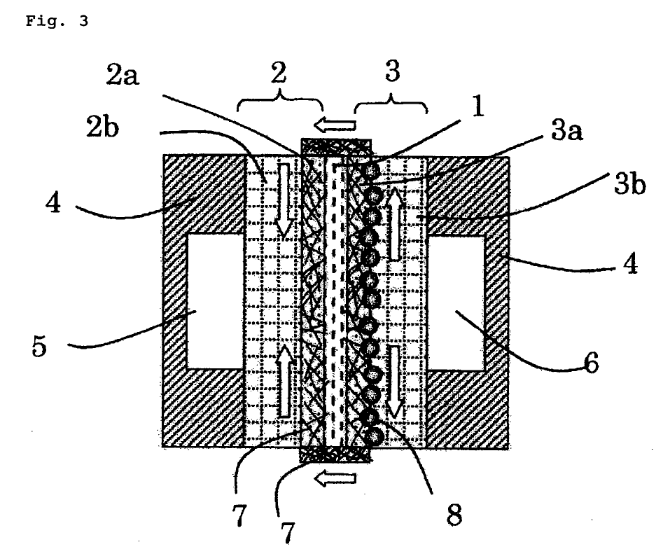

In addition, as shown in FIG. 3, a water-retaining material 7 is allowed to be present at both insides of a fuel electrode 2 and an oxidant electrode 3. Both of the two water-retaining materials are connected outside the edge of a solid polymer electrolyte membrane 1, for example, via the water-retaining material. Thus, water 8 generated at the oxidant electrode 3 is transported toward the fuel electrode 2 by being allowed to pass through inside of the solid polymer electrolyte membrane and also pass outside of the membrane.

When the water-retaining material comprising the fibers of which surface layer contains a metal oxide is combined and integrated only with the catalyst layer of the fuel electrode, it is preferable to collect the water 8 generated at the oxidant electrode 3 and transport it to the water-retaining material of the fuel electrode, for example, via the above-mentioned fibers disposed outside the edge of the solid polymer membrane 1. In this case, the water generated at the oxidant electrode 3 moves via the route not only outside the edge of the solid polymer membrane, but also inside the solid polymer membrane, and is absorbed by the fibers of the fuel electrode. The above-mentioned fibers of the water-retaining material may be in a scattering state where individual fibers are separated from each other, in the form of so-called chopped strands in which fibers form bundles, or in the form of wool. As such fibers, those in the form of fiber cloth such as woven fabric and nonwoven fabric are preferably employed. The fiber cloth is combined and integrated with a catalyst layer by using the above-mentioned fiber cloth, a plane area of which is approximately equal to that of the catalyst layer and a thickness of which is smaller than, preferably approximately equal to, that of the catalyst layer. The water-retaining material may be combined and integrated not only with the fuel electrode but also with the solid polymer electrolyte membrane and also with the catalyst layer of the oxidant electrode. In this case, in a similar way of being combined and integrated with the catalyst layer of the fuel electrode, the fiber cloth is combined and integrated with the solid polymer electrolyte membrane (or the catalyst layer of the oxidant electrode) by using a fiber cloth of the water-retaining material, a plane area of which is approximately equal to that of the solid polymer electrolyte membrane (or the catalyst layer of the oxidant electrode) and a thickness of which is smaller than, preferably approximately equal to, that of the electrolyte membrane (or the catalyst layer). When the water-retaining material is combined and integrated with the catalyst layer of the fuel electrode, the solid polymer electrolyte membrane and the catalyst layer of the oxidant electrode as shown in FIG. 2, it is preferable that the combined thickness of the two catalyst layers and the solid polymer electrolyte membrane be approximately equal to the total thickness of the fiber cloth. Similarly, when the water-retaining material is combined and integrated with the catalyst layer of the fuel electrode and the solid polymer electrolyte membrane, it is preferable that the combined thickness of the catalyst layer and the electrolyte membrane be approximately equal to the total thickness of the fiber cloth used.

The water is physically or chemically adsorbed on the surface of fibers of the water-retaining material and moves in the longitudinal direction of the fibers. If the fibers are in the form of fiber cloth, the fibers adjacent to each other are in contact at their intersections within the fiber cloth. Accordingly, the water passes through the intersections to move to the adjacent fibers successively. As a result, the water moves in the thickness direction and the plane direction of the fiber cloth, and is transported toward the fuel electrode which has a lower moisture concentration. Because spaces penetrate through fibers in the fiber cloth, protons are conducted through the polymer electrolyte or catalyst filled in the spaces. In this way, it is possible to carry out the transportation of water efficiently and continuously and, as a result, the fuel electrode and/or the electrolyte are/is humidified more uniformly.

Additionally, in such constitutions, the catalyst layer of the oxidant electrode may be provided with a water repellent layer on its gas phase side. The draining of water from the oxidant electrode is inhibited, and the water is reused for humidification of the fuel electrode more efficiently by the action of the above-mentioned water-retaining material through the solid polymer electrolyte membrane or through the water-retaining material located outside of the cell.

As the water-retaining material in the present invention used are fibers, at least the surface layer of which contains a metal oxide or products obtained by processing such fibers to form cloth, e.g. woven fabric, nonwoven fabric and paper, using processing techniques including weaving, paper-making and so on. Examples of the above-mentioned metal oxide include silicon oxide (silica), aluminum oxide, zirconium oxide and titanium oxide. Materials which are composed mainly of these metal oxides and also contain alkali metal oxides such as sodium oxide and potassium oxide, transition metal oxides such as calcium oxide, magnesium oxide and barium oxide, and so on may also be employed. The above-mentioned fibers may be composed of such metal oxide. Moreover, the fibers may be organic or inorganic fibers, the surface of which is covered with the above-mentioned metal oxide. As the metal oxide, in particular, under a high temperature at which sulfonic groups derived from the solid polymer electrolyte act well, glass, particularly C-glass or silica glass, which is highly resistant to acid, is preferably employed. Taking account of the cost, use of C-glass is the most preferable. The composition of C-glass is SiO₂: 65 to 72, Al₂O₃: 1 to 7, CaO: 4 to 11, MgO: 0 to 5, B₂O₃: 0 to 8, Na₂O+K₂O: 9 to 17 and ZnO: 0 to 6, each composition expressed in percent by mass. That is to say, C-glass may be employed as a metal oxide, and C-glass fibers are used as the fibers in the present invention. Besides C-glass, E-glass and glass fibers of other compositions which are not very good in view of acid resistance may also be used. Examples of fibers which are preferably used as the fibers in the present invention include fibers obtained by subjecting the surface of the above-mentioned E-glass fibers to (1) silica coating (LPD method, sol-gel method, water glass method), (2) leaching to make it have a silica composition or (3) a combination of leaching and subsequent silica coating to improve its acid resistance at a high temperature. Without treatment (1), (2) or (3), the above-mentioned glass fibers may be used as the fibers in the present invention.

It is preferable to coat the surface of organic fibers or inorganic fibers with silica. When the silica coating is made, there is no particular limitation to methods therefor, and the known methods such as a method comprising crystallization of oxides from metal salts, a sol-gel method, a CVD method and an LPD method. Specific examples include: a method which comprises adding sodium silicate (water glass) into a slurry of a fiber under an alkali environment to precipitate silica on the surface of the fiber as disclosed in JP 46-9555 B (the metal salt method); a method which comprises feeding a mixture of a fiber and tetraalkoxysilane into a basic solution or an alkaline solution and forming a silica coating on the surface of the fiber through hydrolysis of the tetraalkoxysilane as disclosed in JP 48-32415 B and JP 3-54126 A (the sol-gel method); and a method which comprises suspending a fiber in a hydrosilicofluoric acid solution and forming a silica coating on the fiber by destroying the equilibrium with addition of boric acid or aluminum or with elevated temperature as disclosed in JP 3-066764 A (the LPD method). The fiber on which the silica coating is formed may be an organic fiber such as propylene fiber and polyamide fiber besides the above mentioned E-glass and the glass fibers of other compositions. Although the silica coating may be formed on fibers before the fibers are processed into cloth, it may be formed after the fibers are processed into cloth as disclosed later.

The thickness of the silica coating is preferably 10 to 1000 nm. In the case where E-glass fibers are coated with silica, if the thickness of the silica coating is less than 10 nm, the water retention performance and the acid resistance will be insufficient; components present inside the glass fibers will be eluted, resulting in strength reduction or in a bad influence on electrolyte properties. On the other hand, if the thickness is greater than 1000 nm, fibers become too thick, which will result in loss of flexibility, causing difficulties in handling thereof.

When using fiber cloth as the water-retaining material, it is preferable to use woven or nonwoven fabric having a basis weight of 1.0 to 40 g/m² and a thickness of 20 to 1000 μm produced using fibers having an average diameter of 0.10 to 100 μm.

When short glass fibers are used as the fibers of the water-retaining material, their average diameter is preferably 0.10 to 100 μm. Use of fibers having an average diameter smaller than 0.1 μm is unrealistic because it will result in an extremely high production cost. On the other hand, if the average diameter is larger than 100 μm, the specific surface area of the fibers decreases, resulting in difficulty to obtain a high water retaining effect. Moreover, it is difficult to produce glass fibers having such average diameter. Further, the resulting fibers will be poor in flexibility and it will be difficult to produce a uniform electrolyte or nonwoven fabric. The average diameter is more preferably 0.5 to 20 μm.

The average length of the short glass fibers to be used as the water-retaining material preferably is 2 to 50 mm. If it is less than 2 mm, continuous and effective transportation of water will be prevented due to reduced intertwinement of short glass fibers, though some water retaining effect is exerted. On the other hand, if it is greater than 50 mm, it will be difficult to mix the glass fibers with the solid polymer electrolyte to be incorporated in the catalyst layer of the fuel electrode or it will be difficult to disperse the glass fibers in a slurry thereof during a paper making process. It will be, therefore, difficult to produce a homogeneous water-retaining material or a homogeneous catalyst layer of a fuel electrode.

The basis weight of short glass fiber cloth is preferably set to 1.0 to 300 g/m², more preferably 20 to 100 g/m². If it is less than 1.0 g/m², the water retaining effect will be insufficient because the amount of glass fibers is too less. In addition, continuous and effective transportation of water will be prevented due to reduced intertwinement of short glass fibers. If it is greater than 300 g/m², the water-retaining material will become thick and, as a result, the fuel electrode (and the oxidant electrode or the electrolyte membrane, if the water-retaining material is applied also to the oxidant electrode or the electrolyte membrane) will also be thick. Therefore, such increase in the thickness of these components will cause increase in electric resistance, resulting in deterioration of performance of a battery. However, if the density of the water-retaining material is increased for reducing its thickness, spaces for holding the electrolyte membrane of the electrodes will be reduced, resulting in deterioration of performance of a battery.

The cloth of short glass fibers as a water-retaining material is produced using the paper making technique, etc. from short glass fibers to form glass paper or glass nonwoven fabric. The short glass fibers constituting the short glass fiber cloth are in contact with each other at their intersections. The intersections may be bonded with the binder. Alternatively, the fibers may be

intertangled with each other at the intersections without being bonded with the binder. If the binder is used, an inorganic binder such as silica sol is preferred as the binder. As the cloth of glass short fibers, it is preferable to use a glass fiber having a thickness of 20 to 1000 μm. A more preferable thickness is 20 to 300 μm. The thickness of the fiber cloth used in cells is preferably used within the range from (thickness of catalyst layer of fuel electrode) to {(thickness of catalyst layer of fuel electrode)+(thickness of catalyst layer of oxidant electrode)+(thickness of solid polymer electrolyte membrane)}. The thickness is measured with a micrometer. In addition, it is preferable that the cloth has a suitable air spaces among constituting fibers and that the porosity is 60 to 98%.

When using continuous glass fibers as the water-retaining material, it is preferable to use them in the form of glass woven fabric. The weave style of the woven fabric is not particularly limited and examples of the weave style may be satin weave, twill weave, mock leno weave, plain weave, and soon. As the continuous glass fibers, those having a diameter of 5 to 20 μm are preferably used. The basis weight of glass fiber woven fabric is preferably 1.0 to 300 g/m², more preferably 20 to 100 g/m². The thickness thereof is preferably 20 to 1000 μm, more preferably 20 to 300 μm. If the basis weight is less than 1.0 g/m² and the thickness is less than 20 μm, it is difficult to produce such woven fabric and to handle it because of its insufficient strength. On the other hand, if the basis weight is more than 300 g/m² and the thickness is more than 1000 μm, the electrolyte membrane or the electrodes will become thick, which will result in performance fall of the battery, e.g. increase in resistance. The porosity of the glass cloth is preferably 60 to 98%.

In order to retain water efficiently, the glass fibers are more preferably made of porous material, which preferably has a specific surface area of 0.10 to 400 m²/g, more preferably 1.0 to 400 m²/g. The larger the specific surface area is, the more the water retained by physical or chemical adsorption. If, however, the specific surface area is larger than 400 m²/g, it becomes difficult to handle the glass fibers because of their insufficient strength.

The method for making glass fibers porous is not particularly limited, and examples thereof include a method comprising eluting soluble components in the glass by acid treatment to form a porous layer on the surface of the glass, a method comprising forming a layer of inorganic fine particles such as colloidal silica on the surface of glass fibers, and a method comprising coating silica by the above-mentioned sol-gel method.

The woven fabric or nonwoven fabric employed as the water-retaining material may be produced from fibers at least the surface layer of which comprises a metal oxide. Alternatively, nonwoven fabric or woven fabric, used as the core material, made of various kinds of organic fibers the surface of which is coated with silica or the like may also be used as the water-retaining material. Fibers of polyamide, polyolefin or the like are preferable as organic fibers because their constituting fibers can adhere to each other by heat treatment or the like and, therefore, they are of high strength and they can serve as a reinforcement of electrolyte membranes or electrodes.

The method for forming a silica coating on the organic fibers or their cloth is not particularly limited as described above, and the known methods, such as the method comprising crystallizing oxides from metal salts, the sol-gel method, the CVD method and the LPD method, may be used. When using organic fibers as a base material, it is preferable to subject them to a pretreatment such as silane coupling agent treatment in order to improve the adhesion between a silica coat and a base material. In addition, a method comprising adhering silica particles on the surface of a base material may also be employed as a method by which a silica-coated base material can be produced simply and at a low cost. The method for adhering silica particles on the surface of the base material is not particularly limited. Conventionally known methods can be utilized such as an immersion method comprising immersing a constituent material in a suspension of silica particles, followed by drying to fix the particles, and a spray coating method comprising spraying the suspension to the base material, followed by drying to fix the particles.

In this case, the average particle diameter of silica particles is preferably 1 nm to 2 μm. If the average particle diameter is smaller than 1 nm, the cohesion force of the fine particles is too strong and it is difficult to adhere silica particles uniformly to the surface of the base material. If the average particle diameter is greater than 2 μm, the particles become prone to leaving away from the surface of the base material or air spaces as large as gas can pass are formed. If, therefore, it is impossible to fill an electrolyte in the air spaces, battery performance will be decreased. The thickness of the silica coating is preferably 10 to 1000 nm. If it is less than 10 nm, the water retaining property will be insufficient and it will be impossible to secure a sufficient protection of the organic fibers served as a base material. As a result, the strength of the base material will be reduced or the electrolyte characteristics will be badly affected. On the other hand, if the thickness is greater than 1000 nm, the flexibility of the silica coating will be lost and cracks will appear in the silica coating, which will, as a result, become impossible to serve a role as a protective membrane.

The solid polymer electrolyte membrane is not particularly limited and various materials which are usually used may be used. For example, a fluorocarbon polymer in which the polymer skeleton is fluorinated wholly or partially and which possesses an ion exchange group, may be used. Alternatively, a hydrocarbon polymer in which the polymer skeleton is not fluorinated and which possesses an ion exchange group, may be used. The ion exchange groups contained in these polymers are not particularly limited, and the examples of such ion exchange groups are sulfonic acid, carboxylic acid, phosphonic acid and phosphinous acid, etc. In addition, two or more kinds of ion exchange groups may be included. Specific examples thereof include perfluorocarbon sulfonic acid polymers such as Nafion (registered trademark), perfluorocarbon phosphonic acid polymers, trifluorostyrene sulfonic acid polymers and ethylenetetrafluoroethylene-g-styrenesulfonic acid polymers. Specific examples of the solid polymer electrolyte of non-fluorinated hydrocarbons include polysulfone sulfonic acid, polyaryletherketone sulfonic acid, polybenzimidazole alkylsulfonic acid and polybenzimidazole alkylphosphonic acid.

The above-mentioned solid polymer electrolyte may be applied into the fiber cloth which serves as a water-retaining material, and integrated to form an electrolyte membrane. An admixture of a polymer electrolyte and short glass fibers may be integrally formed by roll forming. The application is preferably carried out by applying the electrolyte under pressure to the fiber cloth.

The electrode material for the fuel electrode or the oxidant electrode is not particularly limited. A mixture composed of a conventionally-used carbon black on which a noble metal such as platinum or platinum ruthenium is deposited as a catalyst and an ion exchange resin, etc. may be used as the electrode material.

The fuel electrode (catalyst layer) may be prepared by applying such a fuel electrode material into fiber cloth, which serves as a water-retaining material, thereby to unite and integrate them. The electrode material in the form of powder, suspension in which a powder is suspended in a proper solvent (e.g., water), or paste is applied into fiber cloth, preferably under pressure. After the application, the solvent is removed by drying. In this case, the thickness of the fiber cloth becomes approximately equal to that of the fuel electrode (catalyst layer). Likewise, it is also possible to form an oxidant electrode (catalyst layer) by applying an oxidant electrode material into fiber cloth which serves as a water-retaining material. A mixture of an electrode material and short glass fibers may also be applied to carbon cloth or the like, which will serve as a current collector. When a mixture of the fuel electrode material and short glass fibers is applied to a solid polymer electrolyte membrane which is combined and integrated with the aforementioned water-retaining material, both the fuel electrode and the solid polymer electrolyte membrane can be combined. As the result, it is possible to integrate these components. Likewise, a fuel electrode, a solid polymer electrolyte membrane and an oxidant electrode are all combined with a water-retaining material, resulting in the formation of a unit composed of the fuel electrode, solid polymer electrolyte membrane and oxidant electrode integrated all together with the water-retaining material. With respect to the electrodes and electrolyte membrane prepared in the ways described above, they are connected by means of a hot press or the like, permitting to produce a fuel battery cell in which a water-retaining material is combined and integrated throughout the region from the oxidant electrode to the fuel electrode through the electrolyte membrane.

The fuel cell electrodes and solid polymer electrolyte membrane using the water-retaining material in the present invention can be utilized not only in the case where the fuel is fed in the form of gas but also in the case where the fuel is fed in the form of liquid. For example, in the case of using methanol as the fuel, a conventional solid polymer electrolyte membrane allows methanol to permeate it. As a result, the methanol moves from the fuel electrode side toward the oxidant electrode side, and an oxidation reaction occurs directly on the oxidant electrode. This will cause loss of fuel and fall of power generation efficiency. The permeation of methanol is a phenomenon caused by use of a polymer material as an electrolyte membrane. When using, as in the present invention, a solid polymer electrolyte membrane including, as a water-retaining material, combined and integrated short glass fibers or continuous glass fibers at least the surface layer of which contains a metal oxide, it is possible to prevent expansion of the solid polymer electrolyte caused by water, thereby inhibiting the permeation of methanol. Thus, an effective utilization of fuel is expected to be achieved.

The fuel battery cell and the fuel battery of the present invention can be employed for various applications such as portable power sources of mobile devices typified by automobiles and home-use cogeneration systems.

### INDUSTRIAL APPLICABILITY

According to the present invention, a water-retaining material such as glass fibers is integrated at least with the fuel electrode, and water generated at the oxidant electrode is diffused to the fuel electrode efficiently in a fuel battery. It therefore is possible to operate the battery with stability even under a non-humidified environment without use of a complicated auxiliary device such as a humidifier. In addition, because of no necessity for complicated auxiliary devices, it is possible to design batteries to have a reduced weight and size. Thus, it is possible to achieve cost reduction. Moreover, when uniting and integrating the water-retaining material with a polymer electrolyte membrane, it is possible to enhance the strength of the polymer electrolyte membrane, resulting in reduction of the thickness of the electrolyte membrane. This makes it possible to provide high-efficiency, high-power fuel batteries.

1. A solid polymer electrolyte fuel battery cell comprising a solid polymer electrolyte membrane, a fuel electrode and an oxidant electrode, the both electrodes being disposed on both sides of the membrane, and a pair of current collectors disposed outside the electrodes, wherein a water-retaining material comprising fibers at least the surface layer of which contains a metal oxide is combined and integrated with at least the fuel electrode among the solid polymer electrolyte membrane, the fuel electrode and the oxidant electrode.

2. The solid polymer electrolyte fuel battery cell according to claim 1, wherein the water-retaining material is in the form of fiber cloth.

3. The solid polymer electrolyte fuel battery cell according to claim 2, wherein the fiber cloth comprises fibers having an average diameter of 0.10 to 100 μm and is a woven or nonwoven fabric having a basis weight of 1.0 to 300 g/m² and a thickness of 20 to 1000 μm.

4. The solid polymer electrolyte fuel battery cell according to claim 1, wherein the water-retaining material is combined and integrated with all of the solid polymer electrolyte membrane, the fuel electrode and the oxidant electrode.

5. The solid polymer electrolyte fuel battery cell according to claim 1, wherein the water-retaining material is combined and integrated with both of the fuel electrode and the oxidant electrode.

6. The solid polymer electrolyte fuel battery cell according to claim 5, wherein a water-retaining material combined and integrated within the fuel electrode and a water-retaining material combined and integrated with the oxidant electrode are connected to each other outside the edge of the solid polymer electrolyte membrane.

7. A fuel battery using the solid polymer electrolyte fuel battery cell according to claim 1.

8. A water-retaining material for solid polymer electrolyte fuel battery cells, which comprises a woven fabric at least the surface layer of which contains a metal oxide.

9. The solid polymer electrolyte fuel battery cell according to claim 2, wherein the water-retaining material is combined and integrated with all of the solid polymer electrolyte membrane, the fuel electrode and the oxidant electrode.

10. The solid polymer electrolyte fuel battery cell according to claim 3, wherein the water-retaining material is combined and integrated with all of the solid polymer electrolyte membrane, the fuel electrode and the oxidant electrode.

11. The solid polymer electrolyte fuel battery cell according to claim 2, wherein the water-retaining material is combined and integrated with both of the fuel electrode and the oxidant electrode.

12. The solid polymer electrolyte fuel battery cell according to claim 3, wherein the water-retaining material is combined and integrated with both of the fuel electrode and the oxidant electrode.

13. The solid polymer electrolyte fuel battery cell according to claim 2, wherein a water-retaining material combined and integrated within the fuel electrode and a water-retaining material combined and integrated with the oxidant electrode are connected to each other outside the edge of the solid polymer electrolyte membrane.

14. The solid polymer electrolyte fuel battery cell according to claim 3, wherein a water-retaining material combined and integrated within the fuel electrode and a water-retaining material combined and integrated with the oxidant electrode are connected to each other outside the edge of the solid polymer electrolyte membrane.
